(19) United States
(12) Patent Application Publication
(10) Pub. No.: US 2021/0092062 A1
(43) Pub. Date: Mar. 25, 2021

(54) QUALITY OF EXPERIENCE (QOE) ENHANCEMENT DEVICE AND RELATED TECHNIQUES

(71) Applicant: Citrix Systems, Inc., Fort Lauderdale, FL (US)

(72) Inventors: Praveen Raja Dhanabalan, Bangalore (IN); Naveen Yerramneni, Bangalore (IN); Ramanjaneya Reddy Kamalapuram, Bangalore (IN); Snigdhendu Mukhopadhyay, San Jose, CA (US)

(21) Appl. No.: 16/577,561

(22) Filed: Sep. 20, 2019

(51) Int. Cl. H04L 12/803; H04L 12/927; H04L 12/851; H04L 12/26

(52) U.S. Cl. CPC H04L 47/125; H04L 43/087; H04L 47/2425; H04L 47/805

(57) ABSTRACT

Techniques are disclosed for enhancing quality of experience (QoE) being provided by an application executing in a network based on a determined current QoE of the application. An example methodology implementing the techniques includes determining one or more characteristics of a data flow for an application, computing a score for the execution of the application based on the determined one or more characteristics of the data flow, the score being indicative of a quality of a user experience associated with the application and responsive to determination that the score does not satisfy a threshold, adjusting the data flow so that execution of the application results in a user experience that is satisfactory based on the computed score. In one example, adjusting the data flow includes packet duplication. In another example, adjusting the data flow includes forward error correction.

### BACKGROUND

Quality of service (QoS) generally refers to a measure of the overall performance of a service, such as a telephony, network, or a cloud computing service. In the field of computer networks, QoS represents the performance of a communication network as evaluated by QoS metrics such as bandwidth, delay, jitter, packet loss, and availability, for example. The QoS metrics provide an objective measure of network communication performance.

Another measure of a service or an application is referred to as quality of experience (QoE). QoE generally refers to a measure of the satisfaction (or annoyance) of an end-user's experience in using a communication service or application executing in a communication network. A QoE value represents end-to-end performance of a service or application from a user's perspective. As such, QoE takes into consideration various factors that contribute to a user's perceived quality of performance, such as access, flexibility, mobility, security, cost, personalization, and choice, to provide a few examples. Thus, while QoS metrics provide a quantitative objective measure of network communication performance, QoE metrics provide a subjective indication of a user's perceived performance of network communication—that is, whether network communication performance is satisfactory from a user's perspective.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

According to one illustrative embodiment, a method comprises receiving one or more packets of a data flow via a first path in a network, the one or more packets associated with execution of an application; determining one or more characteristics of the data flow; computing a score for the execution of the application based on the determined one or more characteristics of the data flow, the score being indicative of a quality of a user experience associated with the application; and responsive to determination that the score does not satisfy a threshold, adjusting the data flow so that execution of the application results in a user experience that is satisfactory based on the computed score.

In one aspect, adjusting the data flow comprises determining a second path in the network for the data flow; and duplicating the data flow over the second path to improve the score indicative of a quality of a user experience associated with the application.

In one aspect, the first path and the second path may be the same path.

In one aspect, adjusting the data flow so that execution of the application results in a user experience that is satisfactory based on the computed score comprises determining a second path and a third path in the network for the data flow; identifying which of the second path and the third path has a greater path quality characteristic; and duplicating the data flow over the path having the greater path quality characteristic.

In one aspect, adjusting the data flow so that execution of the application results in a user experience that is satisfactory based on the computed score comprises applying a quality of service (QoS) policy wherein the QoS policy comprises: determining a second path and a third path in the network for the data flow; identifying which of the second path and the third path has a greater path quality characteristic; and duplicating the data flow over the path having the greater path quality characteristic.

In one aspect, adjusting the data flow so that execution of the application results in a user experience that is satisfactory based on the computed score comprises performing forward error correction for the data flow.

In one aspect, adjusting the data flow so that execution of the application results in a user experience that is satisfactory based on the computed score comprises applying a quality of service (QoS) policy wherein the QoS policy includes performing forward error correction for the data flow.

In one aspect, the method may further comprise, subsequent to adjusting the data flow so that execution of the application results in a user experience that is satisfactory based on the computed score and responsive to determination that the score satisfies the threshold, ceasing to adjust the data flow.

In one aspect, ceasing to adjust the data flow includes ceasing packet duplication for the data flow.

In one aspect, ceasing to adjust the data flow includes ceasing forward error correction for the data flow.

In one aspect, the method may further comprise, in addition to the first path, determining a plurality of paths in the network for the data flow; and duplicating the data flow over one or more of the plurality of paths to improve the score indicative of a quality of a user experience associated with the application.

In one aspect, determining the characteristics of the data flow include determining at least one of latency, packet loss, and jitter associated with the data flow.

In one aspect, computing a score for the execution of the application based on the determined one or more characteristics of the data flow includes comparing at least one of the characteristics of the data flow against a corresponding characteristic threshold value.

In accordance with a further illustrative embodiment, a system comprises a memory; and one or more processors in communication with the memory and configured to: receive one or more packets of a data flow via a first path in a network, the one or more packets associated with execution of an application; determine one or more characteristics of the data flow; compute a score for the execution of the application based upon the determined one or more characteristics of the data flow, the score being indicative of a quality of a user experience associated with the application; and responsive to determination that the score does not satisfy a threshold, the one or more processors are configured to adjust the data flow so that execution of the application results in a user experience that is satisfactory based upon the computed score.

In one aspect, the one or more processors are further configured to adjust the data flow by: determining a second path in the network for the data flow; and duplicating the data flow over the second path to improve the score indicative of a quality of a user experience associated with the application.

In one aspect, the second path has one or more of: less packet loss, lower jitter, or less latency relative the first path.

In one aspect, subsequent to adjusting the data flow so that execution of the application results in a user experience that is satisfactory based on the computed score and responsive to determination that the score satisfies the threshold, the one or more processors are further configured to cease adjusting the data flow.

In one aspect, the one or more processors are further configured to adjust the data flow by performing forward error correction for the data flow so that execution of the application results in a user experience that is satisfactory based on the computed score.

In one aspect subsequent to adjusting the data flow so that execution of the application results in a user experience that is satisfactory based on the computed score and responsive to determination that the score satisfies the threshold, the one or more processors are further configured to cease performing forward error correction for the data flow.

In accordance with a still further aspect of the concepts described herein, a non-transitory machine-readable medium encoding instructions that when executed by one or more processors causes a process to be carried out for enhancing quality of experience comprises receiving one or more packets of a data flow via a first path in a network, the one or more packets associated with execution of an application; determining one or more characteristics of the data flow; computing a score for the execution of the application based on the determined one or more characteristics of the data flow, the score being indicative of a quality of a user experience associated with the application; and responsive to determination that the score does not satisfy a threshold, adjusting the data flow so that execution of the application results in a user experience that is satisfactory based on the computed score.

In one aspect, adjusting the data flow comprises: determining a second path in the network for the data flow; and duplicating the data flow over the second path to improve the score indicative of a quality of a user experience associated with the application.

In one aspect, adjusting the data flow so that execution of the application results in a user experience that is satisfactory based on the computed score comprises performing forward error correction for the data flow.

According to one illustrative example embodiment, a method to enhance a quality of experience (QoE) for an application may include receiving one or more packets of a data flow associated with an application execution in a network, wherein the data flow is over a first path in the network. The method may also include determining one or more characteristics of the data flow over the first path in the network and computing an application QoE score for the application execution based on the one or more characteristics of the data flow. The method may further include, responsive to determination that the application QoE score does not satisfy a QoE threshold, applying a Quality of Service (QoS) policy to the data flow to adjust the data flow so as to enhance the quality of experience (QoE) of the application.

In one aspect, applying the QoS policy may include determining a second path in the network for the data flow and duplicating the data flow over the second path. In one such aspect, the first path and the second path are the same path.

In one aspect, applying the QoS policy may include determining a second path and a third path in the network for the data flow, identifying which of the second path and the third path have a greater path quality characteristic (i.e. identifying which is the better path) and duplicating the data flow over the path having the greater path quality characteristic (i.e. duplicating the data flow over the identified better performing path). In embodiments, the path having the greater path quality characteristic is the path having at least one of: less latency, less packet loss, and/or less jitter. It is, of course, possible that one path (e.g. the second path) has some characteristics which are improved relative to (i.e. better than) the third path and some characteristics which worse than the third path. For example, the second path may have less latency but more packet loss and jitter than the third path. In such cases, determining which of the second path and the third path has a greater path quality characteristic will depend upon the specific details of the network and/or the application utilizing the multiple paths.

In one aspect, applying the QoS policy includes performing forward error correction for the data flow.

In one aspect, the method may also include, subsequent to applying the QoS policy and responsive to determination that the application QoE score satisfies the QoE threshold, ceasing application of the QoS policy to the data flow. In one such aspect, ceasing application of the QoS policy includes ceasing packet duplication for the data flow. In another such aspect, ceasing application of the QoS policy includes ceasing forward error correction for the data flow.

In one aspect, the network is a software-defined wide-area network.

In one aspect, the characteristics of the data flow over the first path in the network include at least one of latency, packet loss, and jitter.

In one aspect, the application QoE score is based on a comparison of at least one of the characteristics of the data flow against a corresponding characteristic threshold.

According to one illustrative example embodiment, a system to enhance a quality of experience (QoE) for an application may include one or more non-transitory machine-readable mediums configured to store instructions and one or more processors configured to execute the instructions stored on the one or more non-transitory machine-readable mediums. Execution of the instructions may cause the one or more processors to receive one or more packets of a data flow associated with an application execution in a network, wherein the data flow is over a first path in the network. Execution of the instructions may also cause the one or more processors to determine one or more characteristics of the data flow, compute an application QoE score for the application execution based on the one or more characteristics of the data flow, and, responsive to determination that the application QoE score does not satisfy a QoE threshold, apply a Quality of Service (QoS) policy to the data flow.

In one aspect, to apply the QoS policy may include to determine a second path in the network for the data flow and duplicate the data flow over the second path. In one such aspect, the first path and the second path are the same path. In another such aspect, the second path may have one or more of: less packet loss, lower jitter, or less latency relative to the first path.

In one aspect, to apply the QoS policy may include to determine a second path and a third path in the network for the data flow, identify a better performing path from the second path and the third path (i.e. identifying which of the second and third paths has the better path quality characteristic), and duplicate the data flow over the identified better performing path.

In one aspect, to apply the QoS policy includes to perform forward error correction for the data flow.

In one aspect, execution of the instructions may further cause the one or more processors to, subsequent to applying the QoS policy and responsive to determination that the application QoE score satisfies the QoE threshold, cease application of the QoS policy to the data flow. In one such aspect, to cease application of the QoS policy includes to cease packet duplication for the data flow. In another such aspect, to cease application of the QoS policy includes to cease forward error correction for the data flow.

According to one illustrative example embodiment, a computer program product may include one or more non-transitory machine-readable mediums encoding instructions that when executed by one or more processors cause a process to be carried out for enhancing a quality of experience (QoE) for an application. The process may include receiving one or more packets of a data flow associated with an application execution in a network, wherein the data flow is over a first path in the network, the process may also include determining one or more characteristics of the data flow, computing an application QoE score for the application execution based on the one or more characteristics of the data flow, and, responsive to determination that the application QoE score does not satisfy a QoE threshold, applying a Quality of Service (QoS) policy to the data flow.

In one aspect, applying the QoS policy may include performing packet duplication for the data flow over a second path in the network.

In one aspect, applying the QoS policy may include performing forward error correction for the data flow.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a block diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a block diagram illustrating selected components of an example quality of experience (QoE) enhancement network device, in accordance with an embodiment of the present disclosure.

FIG. 4 is a diagram illustrating an example process flow for enhancing an application quality of experience (QoE) by applying packet duplication, in accordance with an embodiment of the present disclosure.

FIG. 5 is a diagram illustrating an example process flow for enhancing an application quality of experience (QoE) by applying forward error correction, in accordance with an embodiment of the present disclosure.

FIG. 6 is a flow diagram illustrating an example process for enhancing a quality of experience (QoE) of an application, in accordance with an embodiment of the present disclosure.

FIG. 7 is a flow diagram illustrating an example process for enhancing an application quality of experience (QoE) by applying packet duplication, in accordance with an embodiment of the present disclosure.

FIG. 8 is a flow diagram illustrating an example process for enhancing an application quality of experience (QoE) by applying forward error correction, in accordance with an embodiment of the present disclosure.

### DETAILED DESCRIPTION

As noted above, QoE may be seen as a subjective measure of quality perceived by end-users of applications and communication services, while QoS may be seen as an objective measure of the quality of the network services. However, QoE is usually a byproduct of QoS in that the factors that determine application QoE typically depend on network primitives such as latency, packet loss, and jitter, to provide a few examples. An increase in any of these factors will result in a reduction in the QoE provided by the application. This means that one way to enhance the QoE of an application is to enhance the QoS of the network in which the application is running, which is relatively easier to determine and control.

One solution to enhance network QoS is packet duplication. According to this technique, each packet in a flow over a single path is duplicated and sent over multiple paths to have greater assurance that critical data (such as voice or video) will make it to the destination. At the recipient end of the session for that data, the first packet received will be forwarded to the destination and the duplicate packets will be dropped, but, if a packet is dropped during transmission, the duplicated packet will be used in its place. Although packet duplication potentially reduces packet loss and/or packet jitter (since more than one copy of the packet is sent over multiple paths, likely ensuring that one packet can arrive sooner than any other subsequent packet), one drawback with existing packet duplication techniques is the use of additional bandwidth than necessary to ensure redundancy. For example, conventional packet duplication consumes at least two times the actual required bandwidth for the duplicated packets. Another solution to enhance network QoS is forward error correction. Forward error correction is a technique to enhance data transmission reliability by introducing redundant data, commonly referred to as error correcting code, into a payload of the packet prior to data transmission. The error correcting code allows the receiver to detect and correct a limited number of errors that may occur in the message without retransmission. Forward error correction provides the receiver the ability to correct errors in the data without a reverse channel to request retransmission of the data. However, similar to packet duplication, forward error correction is inefficient in that it requires additional bandwidth in the forward channel to send the error correcting code to compensate for increased packet payloads. In a general sense, no efficient techniques are available to dynamically enhance the QoS of a given data flow in response to application QoE.

Thus, and in accordance with an embodiment of the present disclosure, techniques are disclosed for enhancing QoE being provided by an application (also referred to herein more simply as “QoE of an application” for brevity) executing in a network based on a determined QoE of the application. So, for example, if a determined QoE of an executing application falls below a pre-established QoE threshold, then a QoS policy can be applied to a data flow associated with the application to enhance the QoE of the application.

According to an embodiment, an application QoE score for an application executing in a network can be determined from a measure of a quality of a particular path of a data flow associated with the application. The particular path of the data flow can be referred to as a current path in the network in which the application is executing. The measure of quality of a path of a data flow (i.e. a path quality characteristic) can be determined based on characteristics of the data flow that are indicative of the performance of the data flow, such as latency, jitter, and packet loss, to provide three examples.

In embodiment, for example, using such performance characteristics, a measure of a current quality of the data flow can be computed and used as an application QoE score for the application. In another such embodiment, using such performance characteristics, a mean opinion score (MOS) indicative of a current quality of the data flow can be computed and used as an application QoE score for the application.

In embodiments, an application QoE score for an executing application can be computed (e.g., determined from the measure of the current quality of the data flow) and compared against a QoE threshold (e.g., a pre-established threshold). If the application QoE score does not satisfy the QoE threshold (e.g., the application QoE score falls below the QoE threshold), a QoS policy can be applied to the data flow to enhance the QoE of the application. In one embodiment, the QoS policy includes performing packet duplication for the packets of the data flow.

In embodiments, the QoS policy includes performing forward error correction for the packets of the data flow. In any such embodiments, the QoS policy applied to enhance the QoE of the application is ceased (e.g., no longer applied) once the application QoE score satisfies the QoE threshold. Numerous configurations and modifications will be apparent in light of this disclosure.

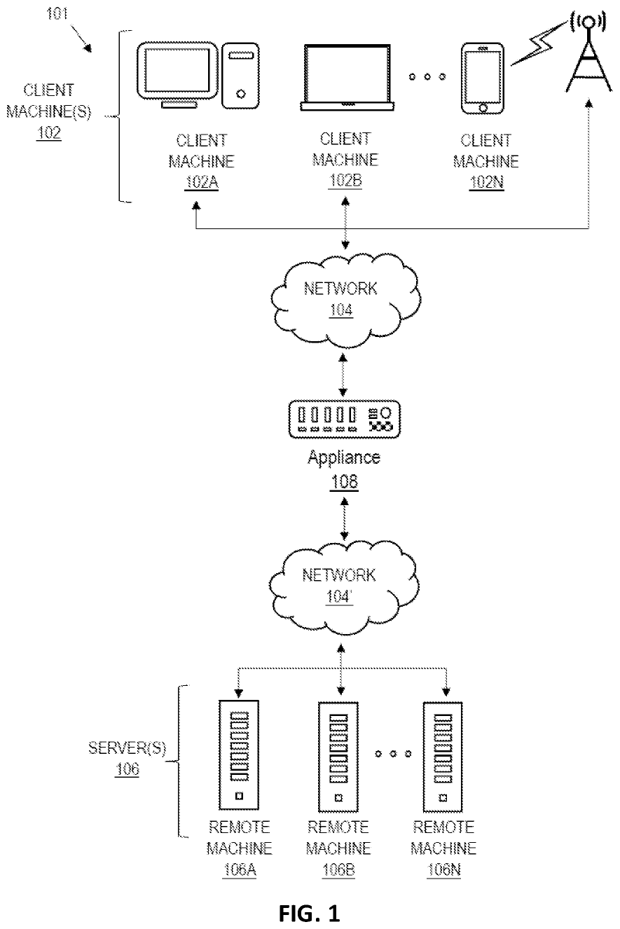

Turning now to the figures, FIG. 1 is a block diagram illustrating an example network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

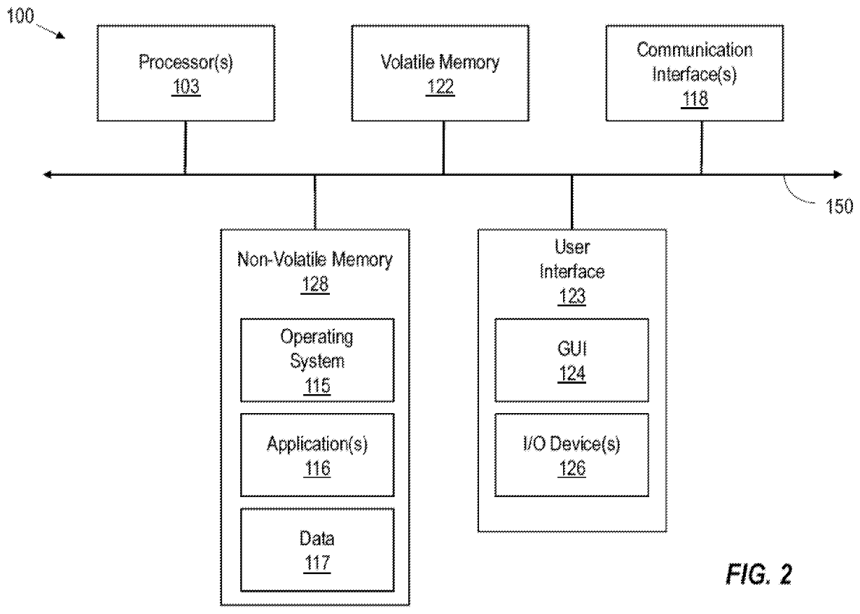

FIG. 2 is a block diagram illustrating selective components of an example computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an example client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed-signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

Referring again to FIG. 1, and in accordance with some embodiments of the present disclosure, enhancing application QoE based on a determined QoE of the application may be implemented in a software-defined network (SDN) such as that illustrated by environment 101 of FIG. 1. An SDN may include a network that is managed by software rather than controlled by hardware. As such, an SDN may support multiple types of connections, such as the Internet connections, Multi-Protocol Label Switching (MPLS) connections, and/or cellular connections (such as Long Term Evolution (LTE), LTE Advanced, Worldwide Interoperability for Microwave Access (WiMAX), 4G, and/or others), to provide a few examples. Additionally, an SDN may support load balancing or load sharing between the various connections. Further, because of the distributed nature of the network, an SDN may support virtual private networks (VPNs), firewalls, and other types of security services. In an SDN, for example, there is a decoupling of the system that makes decisions about where traffic is sent (the control plane) from the underlying systems that forward traffic to the selected destination (the data plane). With its inherent decoupling of the control plane from the data plane, SDN offers improved control of a network through programming (e.g., to be managed via software). As used herein, the term control plane refers to communications and connections used in the control and administration of a network itself, rather than the transmission of data through the network, which may occur at the data plane. As used herein, the term data plane refers to communications and connections used in the transmission and reception of data through the network. For example, the control plane may include administrative traffic directed to a network device within a network, while the data plane may include traffic that passes through network devices within the network.

In some embodiments, an SDN may be implemented as a software-defined wide area network (SD-WAN), local area network (LAN), and/or metropolitan area network (MAN), among others. Although certain embodiments and/or examples of the enhancement of application QoE based on a determined current QoE of the application are described herein in the context of an SD-WAN, it will be appreciated in light of this disclosure that such embodiments and/or examples are not restricted to SD-WANs but are applicable to networks, in the general sense.

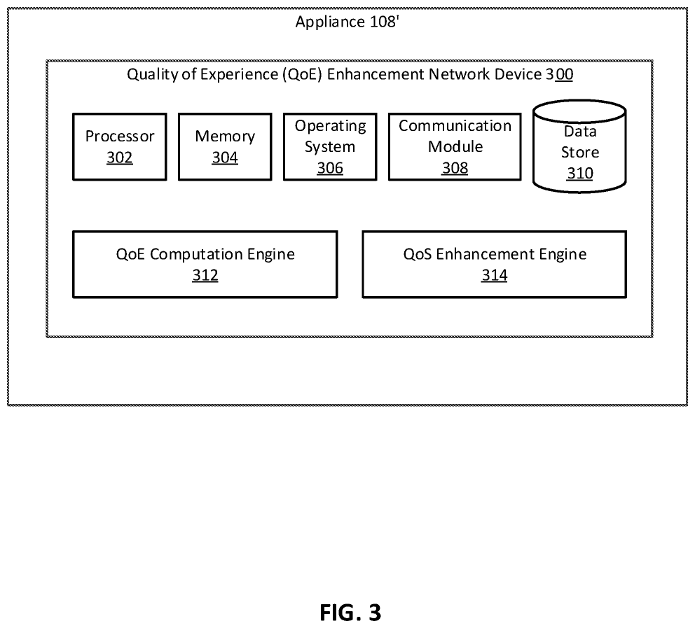

FIG. 3 illustrates selected components of an example quality of experience (QoE) enhancement network device 300. In particular, and in some embodiments, QoE enhancement network device 300 may be implemented as or as part of an edge network device. In the example embodiment of FIG. 3, QoE enhancement network device 300 is illustrated as part of an appliance 108′ which may be the same as or similar to appliance 108 described above in conjunction with FIG. 1 In embodiments, QoE enhancement network device 300 may be positioned at an edge of an SDN, controlled by an SDN controller, and serve as an ingress/egress switch for session initiation requests and application sessions being routed through the SDN controlled by the SDN controller. It should thus be appreciated that QoE enhancement network device 300 may be implemented in a variety of different devices in various physical and logical locations within a network.

In example implementations, QoE enhancement network device 300 illustrated in FIG. 3 can be understood as enabling a bandwidth efficient way to enhance a QoE of an application executing in a network based on a determined QoE of the application. In this regard, in some embodiments, the enhancement of a QoE of an application is achieved by determining (e.g., constantly or periodically determining) an application QoE score for the application and applying a QoS policy to a data flow associated with the application when the application QoE score fails to satisfy a QoE threshold. Applying the QoS policy when the application QoE score falls below the QoE threshold allows for maintaining an intended QoE level for the application in a bandwidth efficient manner in that bandwidth is not utilized to increase QoE of the application when not needed.

In some embodiments, the enhancement of a QoE of an application is achieved by determining (e.g. by computing, inferring or otherwise acquiring) an application QoE score for the application and applying a QoS policy to a data flow associated with the application only when the application QoE score fails to satisfy a pre-established QoE threshold. Applying the QoS policy only when the application QoE score falls below the QoE threshold allows for maintaining an intended QoE level for the application in a bandwidth efficient manner in that bandwidth is not unnecessarily utilized to increase QoE of the application when not needed.

Turning now to FIG. 3, QoE enhancement network device 300 includes a processor 302, a memory 304, an operating system 306, a communication module 308, a data store 310, a QoE computation engine 312, and a QoS enhancement engine 314. In various embodiments, additional components or a subset of the illustrated components can be employed without deviating from the scope of the present disclosure.

Processor 302 may be provided as any suitable processor, such as a reduced instruction set computer (RISC) processor or a complex instruction set computer (CISC) processor. Processor 302 may include one or more coprocessors or controllers to assist in processing operations associated with QoE enhancement network device 300. Memory 304 can be implemented using any suitable type of digital storage, such as one or more of a read-only memory (ROM), flash memory, random access memory (RAM), non-volatile random access memory (NVRAM), or any suitable combination of the foregoing. In some implementations, memory 304 may include one or more non-transitory computer-readable media. Memory 304 may store computer-readable and computer-executable instructions or software, such as QoE computation engine 312 and QoS enhancement engine 314, for implementing the various embodiments as disclosed herein.

Operating system 306 may comprise any suitable networking operating system, such as an Internetwork Operating System (IOS). In some implementations, operating system 306 may comprise any operating system suitable for implementation on network nodes. As will be appreciated in light of this disclosure, the techniques provided herein can be implemented without regard to the particular operating system provided in conjunction with QoE enhancement network device 300, and therefore may also be implemented using any suitable existing or subsequently developed platform.

Communication module 308 can be any appropriate network chip or chipset which allows for wired or wireless communication via a network to one or more of the other components described herein. Communication module 308 can also be configured to provide intra-device communications via a bus or an interconnect. Data store 310 may be a non-transitory computer-readable media and may include, but is not limited to, one or more types of hardware memory, non-transitory tangible media (for example, one or more magnetic disks, one or more optical disks, one or more USB flash drives), and the like.

Data store 310 may store computer-readable and computer-executable instructions or software, such as such as QoE computation engine 312 and QoS enhancement engine 314, for implementing the various embodiments as disclosed herein. Data store 310 may be provided on QoE enhancement network device 300 or provided separately or remotely from QoE enhancement network device 300. In this regard, processor 302, memory 304, operating system 306, communication module 308, and data store 310 are substantially similar to processor 103, volatile memory 122, operating system 115, communication interface 118, and non-volatile memory 128, respectively described previously with respect to FIG. 2.

QoE computation engine 312 is configured to determine the application QoE score for an application executing in a network. QoE computation engine 312 can determine (e.g. compute, infer from other information, or otherwise ascertain) an application QoE score for an application executing in a network from a measure of a current quality of a path of a data flow associated with the application. In such cases, the path of the data flow is a path (e.g., a currently, in-use path) in the network in which the application is executing. For example, QoE computation engine 312 can ascertain the data flow associated with the application using deep packet inspection of the packets received by QoE enhancement network device 300. QoE computation engine 312 can then determine a measure of the current quality of the data flow based on performance characteristics, such as latency, jitter and packet loss. In some embodiments, QoE computation engine 312 can determine (e.g., constant/continuously or periodically) and keep track of the application QoE score for the executing application to maintain an intended QoE level for the executing application.

In one such example embodiment, a measure of a current quality of a data flow can be computed as the percentage of data flows that satisfy (or meet) default thresholds for the performance characteristics latency, jitter, and packet loss, as follows:

data flow quality=(number of data flow samples that satisfy the default threshold values/total number of data flow samples)*100

where the default threshold values for the performance characteristics are as follows:

latency threshold value=160 milliseconds (ms)

jitter threshold value=30 ms

packet loss threshold value=2%.

QoE computation engine 312 can use the computed measure of the current quality of a data flow as an application QoE score for the application. In one example embodiment, an application QoE score in the range between 8-10 indicates that the QoE of the application is good, an application QoE score in the range between 4-8 indicates that the QoE of the application is fair, and an application QoE score in the range between 0-4 indicates that the QoE of the application is poor. It should, of course, be appreciated that the above ranges are only one example of many possible ranges which may be used by a system.

In another such example embodiment, QoE computation engine 312 can compute (or other determine or infer from information) a mean opinion score (MOS) indicative of a quality of a data flow based on one or more performance characteristics of the data flow. A MOS may be computed (or otherwise determined or inferred) using any technique. QoE computation engine 312 can use the computed MOS as an application QoE score for the application. In such embodiments, an application QoE score in the range between 4.3-5.0 indicates that users of the application are very satisfied, an application QoE score in the range between 4.0-4.3 indicates that users of the application are satisfied, an application QoE score in the range between 3.6-4.0 indicates that some users of the application are satisfied, an application QoE score in the range between 3.1-3.6 indicates that many users of the application are dissatisfied, an application QoE score in the range between 2.6-3.1 indicates that almost all users of the application are dissatisfied, and an application QoE score in the range between 1.0-2.6 indicates that use of the application is not recommended.

QoE computation engine 312 is further configured to check that an application QoE score satisfies a QoE threshold (e.g., a pre-established or dynamic threshold). For example, in cases where the application QoE score is determined from the quality of the data flow, the QoE threshold may be set to a suitable value, such as 3.5, 3.6, 3.7, 3.8, 3.9, 4.0, or any other suitable value. In cases where the application QoE score is determined from the MOS indicative of the quality of the data flow, the QoE threshold may be set to a suitable value, such as 7.8, 7.9, 8.0, 8.1, 8.2, or any other suitable value. In any such cases, the QoE threshold defines an intended QoE level for the application. The QoE threshold may be preconfigured, for example, by a provider of QoE enhancement network device 300. In some embodiments, the QoE threshold may be a tunable parameter. For example, a QoE threshold value may be specified in a configuration file that is accessible by QoE enhancement network device 300, and a user (or system administrator) may tune or adjust the QoE threshold value to achieve a desired performance of QoE enhancement network device 300. Note that setting the QoE threshold to a larger value may increase the QoE provided by the application, but decrease performance (e.g., increased use of bandwidth).

In such embodiments, QoE computation engine 312 maintains an intended QoE level for an executing application by checking an application QoE score for the application against the QoE threshold. If an application QoE score satisfies the QoE threshold, then QoE computation engine 312 can conclude that the executing application is providing the intended QoE level for the application. That is, QoE computation engine 312 can conclude that the QoE provided by the executing application is acceptable based on the particular application QoE score and the specified QoE threshold. Otherwise, if the application QoE score does not satisfy the QoE threshold, then QoE computation engine 312 can conclude that the executing application is not providing the intended QoE level for the application. That is, QoE computation engine 312 can conclude that the QoE provided by the executing application is not acceptable based on the particular application QoE score and the specified QoE threshold. In such cases, QoE computation engine 312 can utilize QoS enhancement engine 314 to enhance the QoE of the executing application, as will be further described below.

QoE computation engine 312 is further configured to cease enhancement of the QoE of an executing application upon determining that an executing application is providing the intended QoE level for the application. To do so, in accordance with one embodiment, subsequent to utilizing QoS enhancement engine 314 to enhance the QoE of the executing application, QoE computation engine 312 continues the checking of current application QoE scores for the application against the QoE threshold. If any subsequent current application QoE score satisfies the QoE threshold, then QoE computation engine 312 can conclude that the executing application is providing the intended QoE level for the application. In such cases, QoE computation engine 312 can cause QoS enhancement engine 314 to cease enhancement of the QoE of the executing application.

In some embodiments, the QoE threshold can vary depending on a type of application that is executing in the network. That is, different QoE thresholds may be specified for different types of applications. For example, a first QoE threshold value may be specified for a real-time application such as an audio application, interactive video application, or a telephony application such as voice over IP (VoIP), and a second, different QoE threshold value may be specified for a streaming application such as streamlining video. In such embodiments, QoE computation engine 312 can determine the type of application that is executing and check an application QoE score (e.g., a current application QoE score) for the application against the QoE threshold value specified for that type of application. As will be appreciated in light of this disclosure, the types of applications can vary greatly, and the description provided herein is not intended to be limited to any particular types of applications or the numbers of applications in any particular application type.

QoS enhancement engine 314 is configured to apply a QoS policy to a data flow associated with an executing application to enhance a QoE of the executing application. The data flow is over a path in a network in which the application is executing. In one example embodiment, the QoS policy includes performing packet duplication for the packets of the data flow. To perform packet duplication, QoS enhancement engine 314 can identify another path in the network in which to flow data to the executing application and duplicate the data flow over the identified other path in the network. The result is that the packets of the data flow are sent over two different paths in the network (e.g., a current path and the identified other path).

In one such example embodiment, QoS enhancement engine 314 can identify multiple paths in the network for the data flow and duplicate the data flow over a best performing path of the identified multiple, other paths. The best performing, other path may be determined based on factors such as latency, jitter, and packet loss (to name a few examples) and combinations thereof. Note that the best performing path may be the current path in the network the data flow is over. In such cases, the packets may be duplicated over the current path (e.g., duplicated over the same path). That is, in embodiments it may be desirable or even necessary to send packets twice over the current path. Such an approach may be desirable, for example, when the level or quality of all other identified paths is so low than no meaningful benefit can be gained by duplicating the flow over those paths.

In some embodiments, QoS enhancement engine 314 can identify or otherwise determine a cause of the compromised quality (e.g., the executing application not providing the intended level of quality) and select an additional path for duplicating the data flow based on the identified cause of the comprised quality. Such causes may be the characteristics, such as latency, jitter, and packet loss, of the data flow associated with the application. For example, if the application quality being compromised due to packet loss (e.g., current path is experiencing high packet loss), QoS enhancement engine 314 may duplicate the data flow over an additional path that has less packet loss. As another example, if the application quality being compromised due to high jitter (e.g., current path is experiencing high jitter), QoS enhancement engine 314 may duplicate the data flow over an additional path that has lower jitter. As another example, if the application quality being compromised due to latency, QoS enhancement engine 314 may duplicate the data flow over an additional path that has less latency relative to the current path.

It should be appreciated that in some instances, no other path can be found which is performing at a quality which is as good as or greater than the quality of the current path. Thus, in such instances, QoS enhancement engine 314 may identify multiple paths in the network for the data flow and duplicate the data flow over one of the identified paths that is performing at a lower level or quality than the current path. By duplicating the data flow over a path that is performing at a lower level or quality than the current path, a benefit can still be realized (e.g. the probability of packet loss can still be effectively reduced). For instance, the probability of losing two (2) packets in a row would be reduced. Thus, it is not necessary to duplicate the data flow over a path that is performing at the same or a higher level or quality than the current path to realize at least some benefit. Rather, a benefit may still be realized even in those instances in which a data flow is duplicated over a path that is performing at a lower level or quality than a current path.

Furthermore, in some instances, even if a path that is performing at the same or a higher level or quality than a current path is identified, it may be desirable or even necessary to utilize a path having a lower level or quality than a current path for duplication and save the higher quality path for another purpose. For example, it may be desirable or even necessary to save the higher quality path for use with an application having a higher priority than the current application. Other reasons for not using a higher quality path for duplication may also exist. Regardless of the specific reason, in such instances, by duplicating a data flow over a path that is performing at a lower level or quality than the current path, as noted above, a benefit can still be realized.

In another example embodiment, the QoS policy includes performing forward error correction (FEC) for the packets of the data flow. To perform FEC, QoS enhancement engine 314 can encode the packets of the data flow in a redundant manner using an error correction code. It should be appreciated that different FEC codes may be suitable for different conditions. In general, for transmission on a path having a relatively low QoE score, it may be desirable to utilize a relatively strong FEC code (i.e. an FEC code which induces a relatively high amount of redundancy. It should be noted that such redundancy needs to be transmitted using the available bandwidth of the path, which in turn reduces the effective bit-rate while improving the received effective signal-to-noise ratio.

In embodiments, by utilizing information about the performance of the communication paths, it may be possible to make adjustments as to how the FEC is implemented for use on a particular path (e.g. to address particular deficiencies with the path). For example, in a path having near perfect transmission characteristics (which may manifest itself as a good application QoE score), a relatively weak FEC may be used while in a path having average transmission characteristics (which may manifest itself as a fair application QoE score), an FEC which is stronger than the weak FEC may be used and in a path having poor transmission characteristics (which may manifest itself as a poor application QoE score) an even stronger form of FEC (as compared with the FEC used in the case of a fair application QoE score) may be used.

The embodiments described herein can be implemented in various forms of hardware, software, firmware, or special purpose processors. For example, in one embodiment, a non-transitory computer readable medium includes instructions encoded thereon that, when executed by one or more processors, cause aspects of QoE enhancement network device 300 described herein to be implemented. The instructions can be encoded using any suitable programming language, such as C, C++, object-oriented C, Java, JavaScript, Visual Basic .NET, BASIC, Scala, or alternatively, using custom or proprietary instruction sets. Such instructions can be provided in the form of one or more computer software applications and systems that are tangibly embodied on a memory device, and that can be executed by a computer having any suitable architecture.

The functionalities disclosed herein can optionally be incorporated into a variety of different network appliances and devices, including routers, bridges, switches, gateways, firewalls, nodes, and other network devices and systems that aid in the flow of information (e.g., data) to other network-connected computing devices, to name a few examples. The functionalities disclosed herein can additionally or alternatively be incorporated as part of and/or leverage services provided by separate software applications and systems. For example, in one embodiment, the functionalities disclosed herein can be implemented as part of a software-defined wide-area network (SD-WAN). Additionally or alternatively, the functionalities disclosed herein can be implemented using a virtualization framework, such as network function virtualization, including virtual appliances, for example. The appliances and/or engines disclosed herein may include a number of different modules, sub-modules, or other components of distinct functionality, and can provide information to, or receive information from, still other components and services. These appliances and/or engines can be used, for example, to communicate with input/output devices such as a display screen, a touch sensitive surface, auditory interface, or any other suitable input/output device. Other components and functionality not reflected in the illustrations will be apparent in light of this disclosure, and it will be appreciated that the present disclosure is not intended to be limited to any particular hardware or software configuration. Thus, in other embodiments, the components illustrated in FIG. 3 may include additional, fewer, or alternative subcomponents.

In alternative embodiments, the appliances and engines disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used in this regard, and that the present disclosure is not intended to be limited to any particular system architecture.

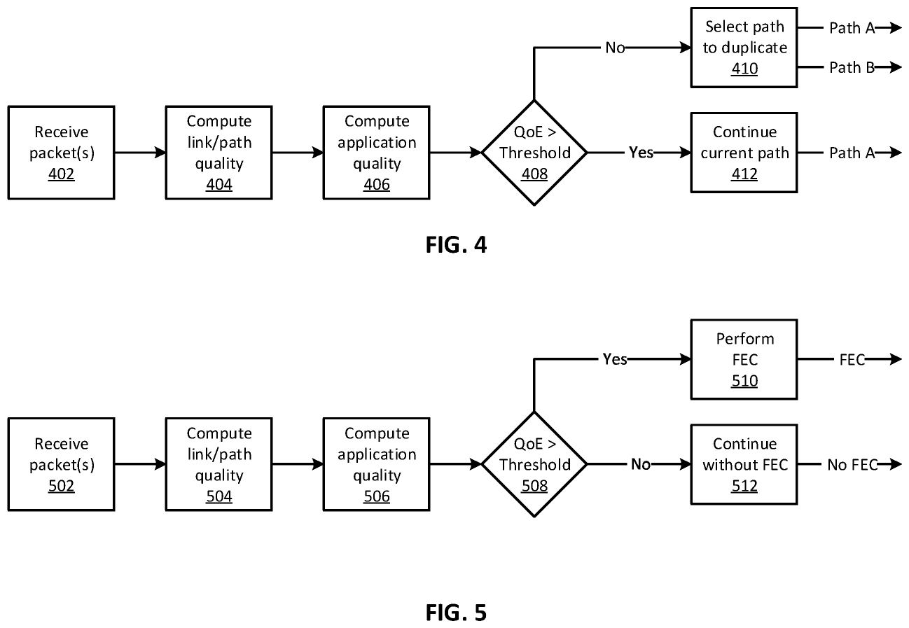

FIG. 4 is a diagram illustrating an example process flow for enhancing an application quality of experience (QoE) by applying packet duplication, in accordance with an embodiment of the present disclosure. QoE enhancement network device 300 may be implemented in an edge network device, which is receiving packets for routing to respective destinations (402). In an example scenario, an application may be executing in a network, such as an SD-WAN network, and the packets received by the QoE enhancement network device may include the packets associated with the executing application. The QoE enhancement network device can ascertain a data flow associated with the executing application and determine that the data flow is over a particular path (current path) in the network. For example, the data flow and the current path of the data flow may be determined using deep packet inspection of the received packets.

The QoE enhancement network device can then compute a measure of quality of the current path of the data flow (404). The measure of a quality of a path of a data flow can be determined based on characteristics of the data flow that are indicative of the performance of the data flow, such as latency, jitter, and packet loss, to provide three examples. The QoE enhancement network device can then compute a measure of quality, such as a QoE, for the executing application (406). The measure of quality may be indicated or otherwise represented using an application QoE score. For example, the application QoE score for the executing application can be determined from the computed measure of the current quality of the current path of the data flow associated with the application.

The QoE enhancement network device can then check the application QoE score against a QoE threshold to determine whether an intended QoE level is being provided by the executing application (408). If the intended QoE level is not being provided by the executing application (e.g., application QoE score is not greater than the pre-established QoE threshold), then the QoE enhancement network device can identify another path in the network suitable for routing the packets in the data flow and duplicate the data flow over the identified additional path (410).

In one embodiment, the identified additional path may be a best performing of the paths in the network that are suitable for routing the packets in the data flow associated with the executing application. For reasons which will be discussed below, in another embodiment, the identified additional path may be a path in the network that is suitable for routing the packets in the data flow associated with the executing application and that is performing at a lower level or quality than the current path. In any case, the packets of the data flow are sent over both the path and the identified additional path to enhance the QoE of the executing application. If the intended QoE level is being provided by the executing application (e.g., application QoE score is greater than the QoE threshold), then the QoE enhancement network device can continue with just sending the data flow associated with the executing application over the current path (412). That is, in this case, the QoE enhancement network device does not perform packet duplication for the packets of the data flow since the application is executing at the intended QoE level.

FIG. 5 is a diagram illustrating an example process flow for enhancing an application quality of experience (QoE) by applying forward error correction, in accordance with an embodiment of the present disclosure. Similar to the previous description with respect to FIG. 4, QoE enhancement network device 300 may be implemented in an edge network device, which is receiving packets for routing to respective destinations (502). In an example scenario, an application may be executing in a network, such as an SD-WAN network, and the packets received by the QoE enhancement network device may include the packets associated with the executing application. The QoE enhancement network device can ascertain a data flow associated with the executing application and determine that the data flow is over a particular path (current path) in the network. For example, the data flow and the path of the data flow may be determined using deep packet inspection of the received packets.

The QoE enhancement network device can then compute a measure of quality of the current path of the data flow (504). The measure of a quality of a path of a data flow can be determined based on characteristics of the data flow that are indicative of the performance of the data flow. The QoE enhancement network device can then compute a measure of quality, such as a QoE, for the executing application (506). The measure of quality may be indicated or otherwise represented using an application QoE score, which can be determined from the computed measure of the current quality of the current path of the data flow associated with the application. The QoE enhancement network device can then check the application QoE score against a QoE threshold to determine whether an intended QoE level is being provided by the executing application (508).

If the intended QoE level is not being provided by the executing application, then the QoE enhancement network device can perform forward error correction for the packets of the data flow (510). In this case, forward error correction is performed for the packets of the data flow to enhance the QoE of the executing application. If the intended QoE level is being provided by the executing application, then the QoE enhancement network device can continue sending the packets of the data flow without forward error correction (512). in this case, the QoE enhancement network device does not perform forward error correction for the packets of the data flow since the application is executing at the intended QoE level.

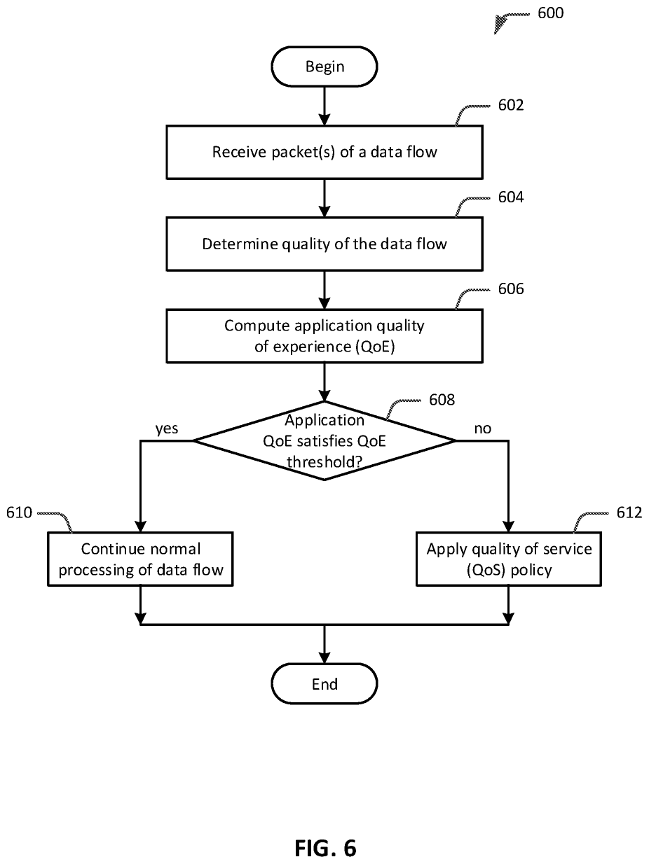

FIG. 6 is a flow diagram illustrating an example process 600 for enhancing a quality of experience (QoE) of an application, in accordance with an embodiment of the present disclosure. The operations, functions, or actions illustrated in example process 600, and example processes 700 and 800 further described below, may in some embodiments be performed by various components of QoE enhancement network device 300 of FIG. 3, such as QoE computation engine 312 and QoS enhancement engine 314. The operations, functions, or actions described in the respective blocks of example process 600, and example processes 700 and 800, may also be stored as computer-executable instructions in a computer-readable medium, such as memory 304 and/or data store 310 of QoE enhancement network device 300 of FIG. 3.

With reference to example process 600 of FIG. 6, operation 602 can be performed by QoE enhancement network device 300 and operations 604-610 can be performed by QoE computation engine 312.

At operation 602, packet(s) of a data flow are received. By way of an example use case, QoE enhancement network device 300 may be implemented as an edge network device that may route data traffic within a network domain. In this example implementation, QoE enhancement network device 300 may receive a data flow of an application that is executing in the network and that is to be routed to another edge network device.

At operation 604, the quality of the data flow of the application is determined. For example, the quality of the data flow can be determined based on one or more QoS metrics, such as bandwidth, delay, jitter, packet loss, and availability, to provide a few examples, of a current path of the data flow. Techniques for determining QoS metrics are known to those of ordinary skill in the art.

At operation 606, a QoE of the application is computed or otherwise determined. The QoE of the application is an indication of the level of quality being provided by the application and may be determined or inferred from the determined quality of the current path of the data flow of the application. An application can have multiple connections that can use one or more paths to send traffic. For each of these paths, the latency, packet loss and jitter can vary based upon their specific network conditions. The average latency, packet loss and jitter observed by each of the connections from the currently active paths may now be computed. Techniques to compute average latency, packet loss and jitter are known and any technique (now known or later discovered) may be used. Application QoE may then be computed from the connections belonging to this particular application. Ideally application QoE may be computed from all connections belonging to this particular application. Using the average latency, packet loss and jitter, one way to compute an application QoE would be to determine a percentage number of connections for an application that is within a threshold (e.g., a pre-configured threshold). For example, assume a threshold for an application is latency=160 ms, packet loss=2% and jitter=30 ms. The latency, packet loss percentage and jitter may be computed for the connections. If the result is that all connections have values less than the corresponding threshold values, the Application QoE would be considered to be 100%.

And continuing with this example, an application QoE of 60% would mean 60% of the connections of that application has (average latency<160 ms) and (average packet loss<2%) and (average jitter<30 ms).

It should, of course, be appreciated that there could be multiple other ways to compute or otherwise determine application QOE, based upon the application. The above example merely illustrates one technique to determine application QoE which may be particularly useful for real-time traffic.

At operation 608, a check is made to determine whether the application is providing an intended level of quality. For example, the intended level of quality may be specified using a QoE threshold (which may, for example, be a single value or a range of values), and an application QoE score for the application can be compared against the QoE threshold. In embodiments, the threshold may be for a particular attribute (such as latency, for example). In embodiments, the threshold may correspond to a combined threshold value for overall performance. In the case of a combined threshold value, individual factors may be weighted to provide a specific level of performance. Such factors may include but are not limited to characteristics of a data flow over a path including but not limited to latency, packet loss, and jitter to name a few examples.

If the application is providing the intended level of quality (e.g., application QoE score satisfies QoE threshold), then, at operation 610, normal processing of the data flow is continued. That is, the QoE of the application is not enhanced since the application is providing the intended QoE level.

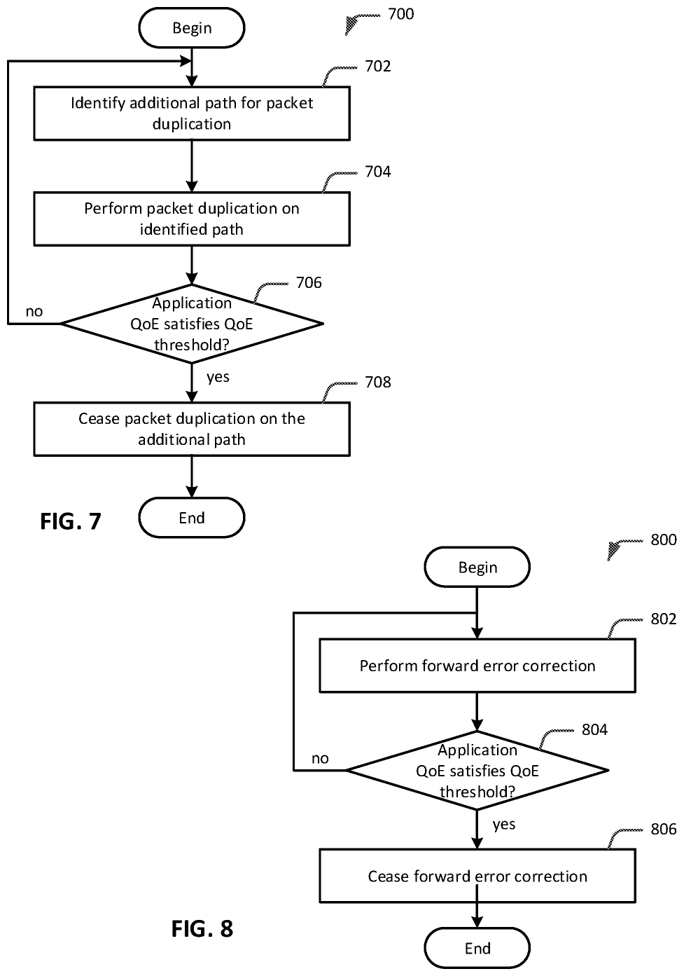

Otherwise, if the application is not providing the intended level of quality (e.g., application QoE score does not satisfy QoE threshold), then, at operation 612, a QoS policy is applied to the data flow of the application to enhance the QoE of the application. FIGS. 7 and 8 provide further details of applying a QoS policy at 612, according to some embodiments.

With reference to example process 700 of FIG. 7, the operations 702, 704, and 708 can be performed by QoS enhancement engine 314, and operation 706 can be performed by QoE computation engine 312. In particular, process 700 is a process for enhancing QoE of an application by applying packet duplication.

At operation 702, an additional path in the network is identified for the data flow of the application. Multiple paths over which an application may be streamed between a source and a destination may be identified using any multi-path technique (e.g. multi-path TCP or MPTCP). The selection of one particular path out of multiple possible paths to use as the additional path is dependent upon a variety of factors as described herein above. In some embodiments, the identified additional path may be the path having the greater path quality characteristic (i.e. a best performing one of multiple available paths in the network that are suitable for routing the packets in the data flow associated with the executing application). In embodiments, the path having the greater path quality characteristic is the path having at least one of: less latency, less packet loss, and/or less jitter. It is, of course, possible that one path (e.g. a second path) has some characteristics which are improved relative to (i.e. better than) a third path and some characteristics which worse than the third path. For example, the second path may have less latency but more packet loss and jitter than the third path. In such cases, determining which of the second path and the third path has a greater path quality characteristic will depend upon the specific details of the network and/or the application utilizing the multiple paths.

At operation 704, the data flow of the application is duplicated on the identified additional path. The result is that the packets of the data flow are sent (e.g., routed) over the current path and the additional path.

At operation 706, a check is made to determine whether the application, as a result of the packet duplication that is being applied, is now providing the intended level of quality. For example, a new application QoE score for the application can be computed that takes into consideration the effects of the packet duplication.

If the application is not providing the intended level of quality (e.g., new application QoE score does not satisfy QoE threshold; for example, the QoE score equals or is less than the QoE threshold), then, at operation 704, duplication of the data flow is continued and processing flows back to operation 702 at which point another additional path is identified because the first additional path was insufficient to increase performance. Another additional path can be identified in at least one of two ways: (1) the first additional path can be supplemented so as to result in the use of multiple additional paths which, when combined, provide the needed performance (i.e. a QoE above the threshold value); or (2) the first additional path can be replaced with a different additional path that provides better performance (e.g. results in a QoE above the threshold value). A combination of (1) and (2) is also possible (i.e. the first additional path can be replaced with a different additional path and multiple additional paths can also be added).

If, on the other hand, the application is providing the intended level of quality (e.g., new application QoE score satisfies (i.e. is greater than) the QoE threshold), then, at operation 708, duplication of the data flow is ceased.

In embodiments, it may be desirable to continue the duplication until the QoE is well above the threshold to (ideally) result in a consistent data flow. In instances in which a first data flow has such poor QoE that duplication is frequently (and in a worst-case scenario, constantly) needed, it may be desirable to perform a check of the original data flow to make sure its performance is acceptable (i.e. a QoE above the threshold value is consistently achieved) before ceasing duplication.

With reference to example process 800 of FIG. 8, the operations 802 and 806 can be performed by QoS enhancement engine 314, and operation 804 can be performed by QoE computation engine 312. In particular, process 800 is a process for enhancing QoE of an application by applying forward error correction.

At operation 802, forward error correction is performed for the data flow of the application. For example, the packets of the data flow can be encoded and sent in a redundant manner using an error correction code.

At operation 804, a check is made to determine whether the application, as a result of the forward error correction that is being applied, is now providing the intended level of quality. That is, a new application QoE score for the application can be computed that takes into consideration the effects of the forward error correction.

In response to the application QoE not satisfying the QoE threshold, (e.g. if the application is not providing the intended level of quality) then processing loops back to operation 802 and forward error correction is continued. As noted above, in embodiments it may be possible to utilize information about the performance of the communication paths and adjust how the FEC is implemented for use on a particular path (e.g. to address particular deficiencies with the path). For example, in some instances a strong FEC code (i.e. an FEC code which induces a high amount of redundancy) may be desirable while in other instances a weak FEC code (i.e. an FEC code which induces an amount of relatively low amount of redundancy as compared to strong FEC code) may be desirable.

In response to the application QoE satisfying the QoE threshold, (e.g. the application is providing the intended level of quality), then processing proceeds to operation 806 and forward error correction for the data flow is ceased.

In embodiments, it may be desirable to continue the FEC until the QoE is well above the threshold to (ideally) result in a consistent data flow. In instances in which a first data flow has such poor QoE that FEC is frequently (and in a worst-case scenario, constantly) needed, it may be desirable to perform a check of the original data flow to make sure its performance is acceptable (i.e. a QoE above the threshold value is consistently achieved) before ceasing FEC operation.

It should be appreciated in light of this disclosure, for processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

It is to be understood that the phraseology and terminology used herein are for the purpose of description and should not be regarded as limiting. Rather, the phrases and terms used herein are to be given their broadest interpretation and meaning. The terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.). Thus, use of “including” and “comprising” and variations thereof are meant to encompass the items listed thereafter and equivalents thereof as well as additional items and equivalents thereof. The use of the terms “connected,” “coupled,” and similar terms, is meant to include both direct and indirect, connecting, and coupling.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

In the above description of the various embodiments, reference is made to the drawings which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Accordingly, all examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. It is thus intended that the scope of the present disclosure be limited not by this detailed description, but rather by the claims appended hereto.

1. A method comprising:
receiving one or more packets of a data flow via a first path in a network, the one or more packets associated with execution of an application having multiple connections that use one or more paths to send traffic for the data flow;
determining a number of the connections that are within thresholds for one or more Quality of Service (QoS) metrics;
computing a quality of experience (QoE) score for the execution of the application based on the number of connections within the thresholds for the one or more QoS metrics, the QoE score being indicative of a quality of a user experience associated with the application; and
responsive to determination that the QoE score does not satisfy a QoE threshold, adjusting the data flow so that execution of the application results in a user experience that is satisfactory based on the computed QoE score.

2. The method of claim 1, wherein adjusting the data flow comprises:
determining a second path in the network for the data flow; and
duplicating the data flow over the second path to improve the QoE score indicative of a quality of a user experience associated with the application.

3. The method of claim 2, wherein the first path and the second path are the same path.

4. The method of claim 1, wherein adjusting the data flow so that execution of the application results in a user experience that is satisfactory based on the computed QoE score comprises:
determining a second path and a third path in the network for the data flow;
identifying which of the second path and the third path has a greater path quality characteristic; and
duplicating the data flow over the path having the greater path quality characteristic.

5. The method of claim 1, wherein adjusting the data flow so that execution of the application results in a user experience that is satisfactory based on the computed QoE score comprises performing forward error correction for the data flow.

6. The method of claim 1, further comprising, subsequent to adjusting the data flow so that execution of the application results in a user experience that is satisfactory based on the computed QoE score and responsive to determination that the QoE score satisfies the QoE threshold, ceasing to adjust the data flow.

7. The method of claim 6, wherein ceasing to adjust the data flow includes ceasing packet duplication for the data flow.

8. The method of claim 6, wherein ceasing to adjust the data flow includes ceasing forward error correction for the data flow.

9. The method of claim 1, further comprising:
in addition to the first path, determining a plurality of paths in the network for the data flow; and
duplicating the data flow over one or more of the plurality of paths to improve the QoE score indicative of a quality of a user experience associated with the application.

10. (canceled)

11. The method of claim 1, wherein computing the QoE score includes comparing at least one characteristic of the data flow against a corresponding characteristic threshold.

12. A system comprising:
a memory; and
one or more processors operably coupled to the memory, the one or more processors configured to execute instructions stored in the memory that when executed cause the one or more processors to:
receive one or more packets of a data flow via a first path in a network, the one or more packets associated with execution of an application having multiple connections that use one or more paths to send traffic for the data flow;
determine a number of the connections that are within thresholds for one or more Quality of Service (QoS) metrics;
compute a quality off experience (QoE) score for the execution of the application based on the number of connections within the thresholds for the one or more QoS metrics, the QoE score being indicative of a quality of a user experience associated with the application; and
responsive to determination that the QoE score does not satisfy a QoE threshold, the one or more processors are configured to adjust the data flow so that execution of the application results in a user experience that is satisfactory based on the computed QoE score.

13. The system of claim 12, wherein execution of the instructions causes the one or more processors to adjust the data flow by:
determining a second path in the network for the data flow; and
duplicating the data flow over the second path to improve the QoE score indicative of a quality of a user experience associated with the application.

14. The system of claim 13, wherein execution of the instructions causes the one or more processors to adjust the data flow by determining a second path having one or more of: less packet loss, lower jitter, or less latency relative the first path.

15. The system of claim 12, wherein execution of the instructions causes the one or more processors to, subsequent to adjusting the data flow so that execution of the application results in a user experience that is satisfactory based on the computed QoE score and responsive to determination that the QoE score satisfies the QoE threshold, cease to adjust the data flow.

16. The system of claim 12, wherein execution of the instructions causes the one or more processors to perform forward error correction for the data flow so that execution of the application results in a user experience that is satisfactory based on the computed QoE score.

17. The system of claim 12, wherein execution of the instructions causes the one or more processors to, subsequent to adjusting the data flow so that execution of the application results in a user experience that is satisfactory based on the computed QoE score and responsive to determination that the QoE score satisfies the QoE threshold, cease to perform forward error correction for the data flow.

18. A non-transitory machine-readable medium encoding instructions that when executed by one or more processors, cause a process to be carried out for enhancing a quality of user experience, the process comprising:
receiving one or more packets of a data flow via a first path in a network, the one or more packets associated with execution of an application having multiple connections that use one or more paths to send traffic for the data flow;
determining a number of the connections that are within thresholds for one or more Quality of Service (QoS) metrics;
computing a quality of experience (QoE) score for the execution of the application based upon the number of connections within the thresholds for the one or more QoS metrics, the QoE score being indicative of a quality of a user experience associated with the application; and
responsive to determination that the QoE score does not satisfy a QoE threshold, adjusting the data flow so that execution of the application results in a user experience that is satisfactory based on the computed QoE score.

19. The non-transitory machine-readable medium of claim 18, wherein adjusting the data flow comprises:
determining a second path in the network for the data flow; and
duplicating the data flow over the second path to improve the QoE score indicative of a quality of a user experience associated with the application.

20. The non-transitory machine-readable medium of claim 18, wherein adjusting the data flow so that execution of the application results in a user experience that is satisfactory based on the computed QoE score comprises performing forward error correction for the data flow.
